(19) United States
(12) Patent Application Publication
(10) Pub. No.: US 2016/0254984 A1
(43) Pub. Date: Sep. 1, 2016

(54) METHOD AND SYSTEM FOR DELIVERING SERVICE-ENABLED FLOW PATHS ACROSS MULTIPLE DOMAINS IN SDN NETWORKS

(71) Applicant: ARGELA YAZILIM VE BILISIM TEKNOLOJILERI SAN. VE TIC. A.S., ISTANBUL (TR)

(72) Inventors: A. MURAT TEKALP, ISTANBUL (TR); ERHAN LOKMAN, ISTANBUL (TR); SEYHAN CIVANLAR, ISTANBUL (TR); BULENT KAYTAZ, ISTANBUL (TR)

(21) Appl. No.: 14/633,446

(22) Filed: Feb. 27, 2015

(51) Int. Cl. H04L 12/751; H04L 12/721

(52) U.S. Cl. CPC H04L 45/02; H04L 45/38

(57) ABSTRACT

Systems and methods are described to dynamically set up and tear down service-enabled flow-paths across multiple SDN domains. An SDN controller of a domain periodically shares with other SDN controllers (of other domains) availability of service-enabled paths (aka, a summarized topology) of its respective network as well as associated service parameters of each path segment using a global nomenclature (aka, a dictionary) with other SDN controllers so as to enable each controller to understand and interpret the shared data in the same manner. Hence, each SDN controller can autonomously construct a complete network graph of available service-enabled paths across many domains. Another feature is the use of summarized (internal) topology of each domain as opposed to just using the peering-link related service information to compute desirable path alternatives.

### BACKGROUND OF THE INVENTION

1. Field of Invention

The disclosed invention generally relates to the Internet architecture and specifically to many interconnected Software Defined Network (SDN) domains, each domain spanning a different administratively-managed network or Autonomous System (AS) which is comprised of at least one controller and many forwarders. Provisioning of an end-to-end path with specific service levels over the Internet requires establishing a, so called, service-enabled flow-path traversing multiple SDN domains. According to an aspect of this invention, in order to enable an SDN controller to determine such a flow-path autonomously, each SDN controller must periodically advertise its service-enabled paths to other SDN controllers. In particular, this invention relates to a system and method for dynamically constructing a service-enabled flow-path, wherein said service can be Quality of Service (QoS) enabled path, a highly reliable path or a highly secure path service, that traverses many such domains between sender(s) and receiver(s), and requires a transport path with certain quantitative or qualitative service level requirements (e.g., low price, high throughput, low packet loss, high availability and/or low packet delay). More specifically, the invention relates to how SDN controllers of different domains share summarized topology information on service-enabled paths in their respective networks with other SDN controllers so as to enabling an autonomous decision-making for an end to end flow-path in real-time by each SDN controller (in contrast to a per-hop path determination of the current public Internet). Doing so, an SDN controller is presented with several service-enabled path alternatives via another SDN domain (or domains) to choose from or to negotiate with other SDN controllers. The invention also describes a system and method for computation of an optimal path for a flow using such advertised summarized topology information. It also covers possible protocols by which an SDN controller can share summarized topology information with other SDN controllers, and reserve and release an end to end flow traversing other SDN controllers' networks.

2. Discussion of Related Art

U.S. Patent Application 2008/026187 teaches a method for providing Virtual Private Network (VPN) services across Autonomous Systems using MPLS protocol. It does not, however, address SDN networks or dynamic flow path determination by using a network graph.

U.S. Pat. No. 8,724,514 teaches a novel method for controlling the advertisement of routing data to neighbor routers to enhance BGP. A router can receive and propagate reachability data (prefixes) learnt from its neighbor routers' neighbors, and hence enable construction of a full or partial network graph. However, this patent does not address how such data will be used to construct flow paths.

U.S. Patent Application US 2014/0307556 describes a control plane functionality to configure data plane in SDN networks using a logical topology representation, and a mapping from the logical (abstracted) topology to actual SDN nodes. The logical topology can be determined by a customer, whereas the mapping from that topology to physical SDN nodes is determined using a control plane functionality.

However, such prior art fails to teach various aspects of Applicants' invention as: (i) there is no need to use an orchestrator or an equivalent higher-level authority then the SDN controllers; (ii) that is all negotiations between multiple operators are carried out with machine-to-machine between SDN controllers.

Embodiments of the present invention are an improvement over prior art systems and methods.

### SUMMARY OF THE INVENTION

This invention relates to dynamically setting up and tearing down service-enabled flow-paths across multiple SDN domains. An SDN controller of a domain periodically shares with other SDN controllers (of other domains) availability of service-enabled paths (aka, a summarized topology) of its respective network as well as associated service parameters of each path segment using a global nomenclature (aka, a dictionary) with other SDN controllers so as to enable each controller to understand and interpret the shared data in the same manner. Doing so, each SDN controller can autonomously construct a complete network graph of available service-enabled paths across a wide-area network of many domains. This feature is unique to SDN networks since the current public Internet has only knowledge of next-hop's (a ‘hop’ is a ‘domain’ in the inter-domain SDN routing case) network resource availability. Another unique aspect of this invention is the use of summarized (internal) topology of each domain as opposed to just using the peering-link related service information to compute desirable path alternatives. An SDN controller can stitch summarized topology links and peering links to produce a graph with many flow-paths across the Internet, and determine the best path amongst them. The invention describes how this information is shared, how the best path is computed, and how that path is reserved and released across many domains through communications between SDN controllers.

When an application, such as video streaming, requires a QoS enabled path across multiple domains between the source and destination (where source is, for example, a computer sending a video and destination is another computer receiving that video), the destination network's SDN controller can calculate the best possible QoS-enabled flow path towards the source, based on the most recent service-topology information communicated to it by all other SDN controllers in the network. Similarly, an application may require a highly secure or a highly reliable path (or both) for a top-secret military application. The SDN controller can determine such a flow path based on information shared by other controllers. Said communication can be performed periodically or even on a per-event basis (i.e., when changes occur in the network conditions). Once such a determination is made, the destination network's SDN controller sends a sequence of signaling messages using Internet Protocol (IP) to SDN controllers along the determined path to reserve the resources on that calculated best path. The signaling may also be used to renegotiate service parameters during the lifetime of the flow or just to it tear down.

In one embodiment, the present invention provided an Internet protocol (IP) based network system with inter-domain topology sharing comprising: (a) a first software defined network (SDN) domain comprising a first controller, a first set of forwarders, and a first storage; (b) a second SDN domain comprising a second controller, a second set of forwarders, and a second storage; (c) the first storage storing first domain topology information associated with the first SDN and second domain topology information associated with the second SDN and advertised by the second controller, (d) the second storage the storing second domain topology information associated with the second SDN and first domain topology information associated with the first SDN advertised by the first controller, and (e) wherein each of the first and second controllers autonomously determining an end-to-end flow path for traversal between the first and second SDN domains based on stored topology information.

In another embodiment, the present invention discloses a method as implemented in a first controller in a first software defined network (SDN) comprising: storing first domain topology information associated with the first SDN in a first database; transmitting a first advertisement message to a second SDN controller in a second SDN domain, the first advertisement message comprising the first domain topology information associated with the first SDN, and receiving a second advertisement message from a second SDN domain controller in the second SDN domain, the second advertisement message comprising second domain topology information associated with the second SDN; storing the received second domain topology information associated with the second SDN in the first database, and wherein the first controller autonomously determining an end-to-end flow path for traversal between the first and second SDN domains based on stored topology information in the first database.

In yet another embodiment, the present invention discloses a first software defined network (SDN) controller that is part of a first SDN domain and operable on an Internet protocol (IP) based network system comprising: (a) a service topology information base sub-system storing data of available service enabled paths and associated service metrics between end points in the first SDN domain and a second SDN domain constructed based on service topology information gathered by the first SDN controller and service topology messages advertised by a second SDN controller associated with the second SDN domain; (b) a flow path constructor sub-system determining an end-to-end flow path between the end points based on both multiple service path topology alternatives stored in the service topology information base sub-system and a pre-determined algorithm (e.g., heuristic algorithm, approximation algorithm, and Lagrangian relaxation based aggregated cost (LARAC) algorithm); and (c) a resource reservation sub-system communicating with the second controller in the second SDN domain to reserve, negotiate or release the end-to-end flow path. The SDN controller may also have any of the following features: a flow tracker sub-system to monitor and track the end-to-end flow path once activated, a topology summarizer sub-system to determine a summarized service-enabled topology/graph of the first SDN domain to be communicated to the second controller in the second SDN domain, and/or a topology communicator sub-system to advertise summarized service-enabled topology/graph of the first SDN domain to the second controller in the second SDN domain.

The present invention also discloses a non-transitory computer-readable medium containing instructions that, when executed by a processor in a first controller in a first software defined network (SDN), cause the first controller to: store first domain topology information associated with the first SDN in a first database; transmit a first advertisement message to a second SDN controller in a second SDN domain, the first advertisement message comprising the first domain topology information associated with the first SDN, and receive a second advertisement message from a second SDN domain controller in the second SDN domain, the second advertisement message comprising second domain topology information associated with the second SDN; store the received second domain topology information associated with the second SDN in the first database, and autonomously determine an end-to-end flow path for traversal between the first and second SDN domains based on stored topology information in the first database.

### BRIEF DESCRIPTION OF THE DRAWINGS

The present disclosure, in accordance with one or more various examples, is described in detail with reference to the following figures. The drawings are provided for purposes of illustration only and merely depict examples of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 illustrates a high level diagram of a prior art network comprised of two interconnected SDN domains.

FIG. 2 illustrates an exemplifying connectivity of control and data planes of four prior art interconnected SDN domains.

FIG. 3 illustrates an exemplifying topology of four interconnected prior art SDN domains.

FIG. 4 illustrates an exemplifying summarized topology of four interconnected SDN domains as perceived by Domain G1 according to this invention.

FIG. 5 illustrates a block diagram of an SDN Controller's software subcomponents according to this invention, enabling an end-to-end service-enabled flow path establishment across multiple domains.

FIG. 6 illustrates an example flowchart outlining the steps of one SDN controller collecting summarized topology information from other SDN controllers.

FIG. 7 illustrates an example flowchart outlining the steps of calculating, reserving, tracking and finally releasing a flow-path across multiple SDN domains.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein.

SDN is a new approach for IP networking that allows decoupling of control and data planes. Decisions about traffic routing are performed at the control plane, while traffic forwarding according to the rules determined by the control plane is performed at the data plane. An SDN Controller is the software where control plane decisions are performed. It nay reside in a single computer or may be distributed to many computers,

SDN applications are written in or on the SDN controller, which enable management of data plane routes differently based on specific application needs.

SDN controller is a logically centralized entity in charge of (i) translating the requirements from the SDN application down to the data path and providing applications with a summarized view of the network (which may include statistics and events). It is mainly comprised of a control Logic, a control to data-plane interface, and an API set for applications to use or program SDN controller. Definition as a logically centralized entity neither prescribes nor precludes implementation details such as the federation of multiple controllers, the hierarchical connection of controllers, communication interfaces between controllers, nor virtualization or slicing of network resources. A possible control-to-data-Plane interface is OpenFlow defined by the Open Networking Foundation, ONF.

The SDN data plane is where forwarding and data processing is performed. A data plane entity s a so called forwarder, which contains one or more traffic forwarding engines with traffic processing functions, an interface to the SDN controller to receive control decisions and to send measurement on data plane.

The SDN control-to-data is the interface defined between an SDN controller and a forwarder, which provides at least (i) programmatic control of all forwarding operations, (ii) capabilities advertisement, (iii) statistics reporting, and (iv) event notification. SDN requires a method for the control plane to communicate with the data plane. One such mechanism is the OpenFlow, which is often misunderstood to be equivalent to SDN, but other mechanisms/protocols could also fit into the concept. Therefore, this patent application is not reliant on the OpenFlow protocol.

SDN controller also has a north-bound interface towards SDN applications and typically provides abstract network views and enable direct expression of network behavior and requirements.

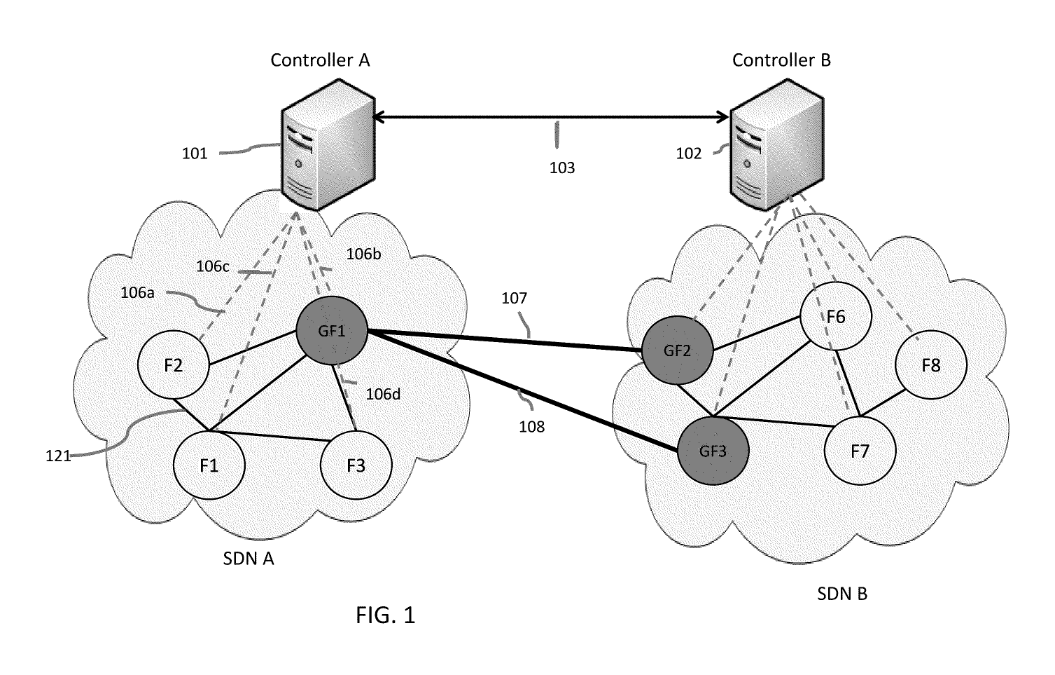

For the purposes of this invention, a prior art SDN domain is comprised of a controller, and many forwarders controlled by said controller. Illustrated in FIG. 1 is a simple exemplifying network with two SDN domains A and B, where domain A is controlled by controller A 101 and domain B is controlled by controller B 102.

The network of SDN A's data plane is comprised of forwarders F1, F2, F3 and GF1 where F1, F2 and F3 are so called internal forwarders (i.e., has only connectivity to other forwarders within the same domain), while GF1 is a gateway forwarder (i.e., has at least one connectivity to at least one forwarder in another SDN's domain; SDN B in this specific case). Note that, similarly, SDN B′s data plane is comprised of internal forwarders F6, F7 and F8, and gateway forwarders GF2 and GF3, both of which connects to GF1 of SDN domain A with interconnection links 107 and 108, respectively. These two links are called inter-SDN links (also known in the public Internet as peering-links), while links such as those between F1 and F2, are called intra-SDN links.

SDN controller 101 attaches to F1, F2, F3 and GF1 with links labeled 106a-d with a control-to-data plane interface running a control-to-data plane protocol such as OpenFlow. Similarly, controller 102 attaches to forwarders of SDN Domain B, communicating with a protocol such as OpenFlow. Meanwhile, controllers 101 and 102 are attached to each other with link 103 to exchange control plane information regarding their respective domains.

Inter-Domain Topology Sharing

The interconnectivity between SDN controllers of different domains may form a physically separate ‘inter-domain control plane network’ that runs on a separate set of facilities than those of the data plane facilities of SDN domains. Alternatively, said interconnectivity may share the same physical facilities with the inter-domain data plane networks. In this scenario, the inter-domain control plane traffic is put on a path on the inter-domain data network on a so called ‘inter-domain control plane flow’, where the end points of the flow are essentially the two SDN controllers. From the perspective of this invention, these two networking scenarios are indifferent since the same or highly similar system and methods can be applied.

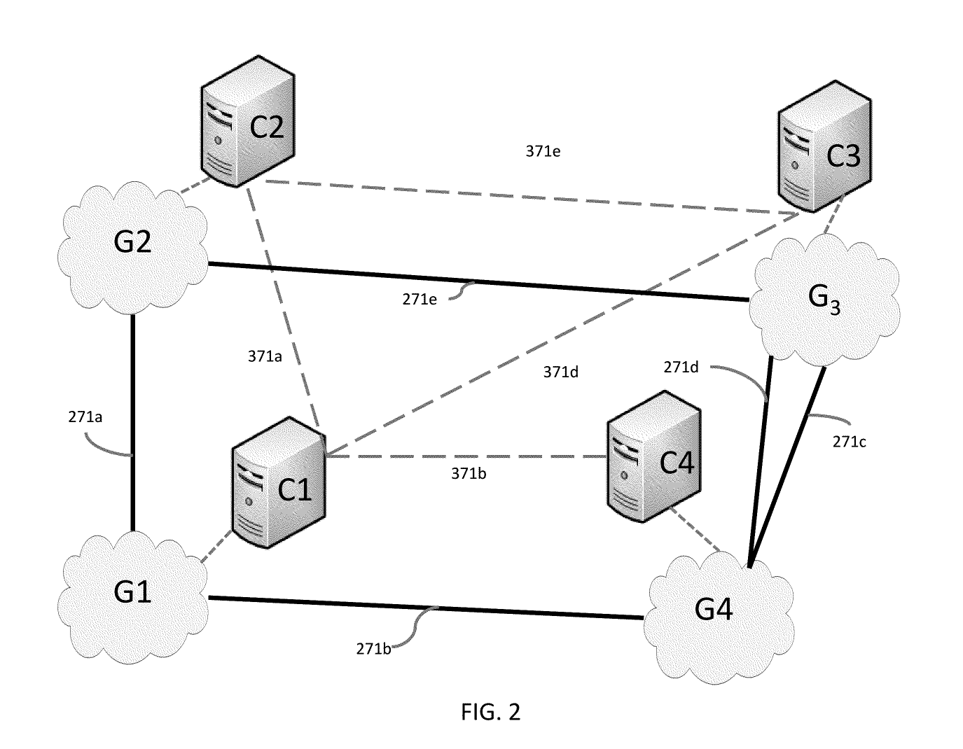

FIG. 2 shows a prior art SDN network comprised of four different SDN domains, illustrated as clouds G1, G2, G3 and G4, which are controlled by SDN controllers C1, C2, C3 and C4, respectively. Note that the links 271a through 271e form the ‘inter-domain data plane’ network (or peering network). These links are between the said gateway forwarders of each domain (such as GF1, GF2 and GF3 of FIG. 1). The ‘internal data plane’ connectivity within each domain is not illustrated for the sake of simplicity. Links 371a, 371b, 371d and 371e form the ‘inter-domain control plane’ network. A close look at the diagram clearly shows that the inter-domain data plane and inter-domain control plane networks may have different network graphs. For example, while C1 is directly connected to C2, C3 and C4, G1 is only connected to G2 and G4.

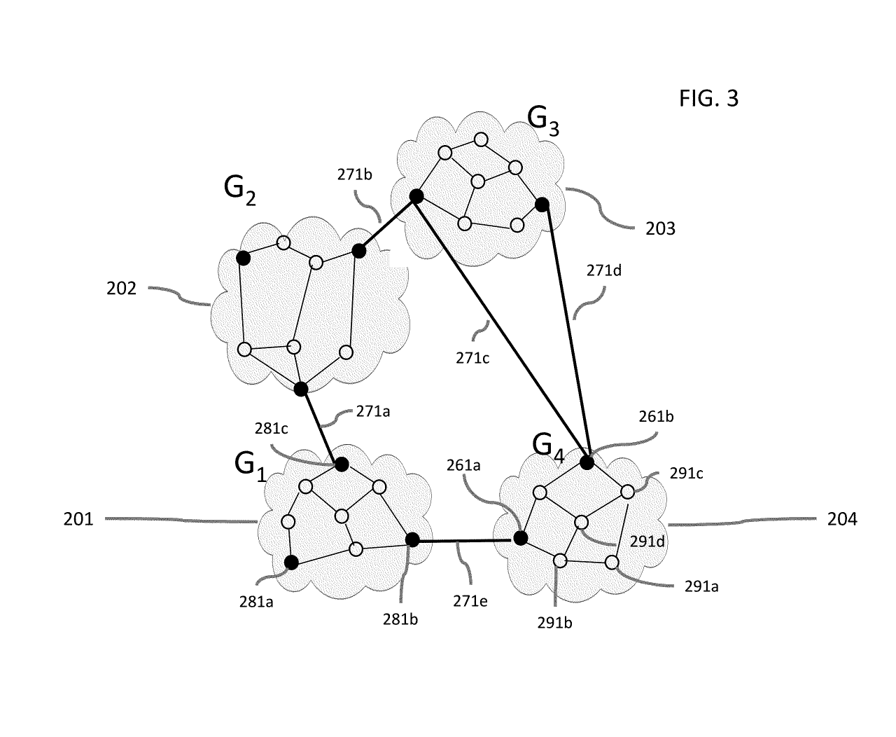

The internal topologies of FIG. 2's SDN networks are illustrated in FIG. 3. Note that a distinction is made between an ‘actual’ and ‘a ‘summarized’ internal topology since an SDN domain may share only the graph of summarized internal topology with other SDN controllers.

The summarized topology definition is fairly broad. It may have, for example, just those links with a specific service-level requirement. This topology is either a subset of the actual network topology, or simply a completely virtual topology of the internal network represented by a grid of links between gateway forwarders of a domain (a star or a mesh, for example). Only the SDN domain controller of each domain can perform the mapping from the summarized topology links to actual topology links of the network.

Note that the cloud G1 is the SDN domain 201, where there are four internal forwarders (hallow circles) and three gateway forwarders (dark circles), 281a, 281b and 281c. Similarly, SDN domain 204, illustrated as cloud G4, has four internal forwarders, and two gateway forwarders labeled as 261a and 261b. For example, said link 271e of FIG. 1 runs between the gateway forwarders 281b and 291b. Note that not all the links and forwarders are labeled and explained in detail for the sake of simplicity.

The future Internet topology according to this invention can be represented as an interconnected set of SDN domains, each domain controlled by a controller (or possibly a federation of controllers which are either mirror image of each other—e.g., primary, secondary configuration, or contain partial distributed control data associated with parts of the SDN domain—e.g., master-slave configuration) and comprised of a topology/graph of interconnected internal and gateway forwarders. Such a network may also dictate a different ‘control plane inter-domain topology’ and ‘data plane inter-domain topology’, as clearly illustrated in FIG. 2. From the perspective of this invention, different controller distribution mechanisms as stated above within an SDN domain are irrelevant to the invention.

Note that an SDN controller does not necessarily need to know the actual internal data plane topology of another SDN domain, nor that domain may want to share its internal domain details with other domains. All it needs to know is a data plane topology between the gateway forwarders to determine how to route a flow from a source SDN domain to a destination SDN domain (possibly via other SDN domains) in such a way that certain service level requirements are met. That said, each SDN controller will need to know more about the service capabilities of each SDN domain along the path of the service enabled flow. Such a requirement does not exist for best effort traffic.

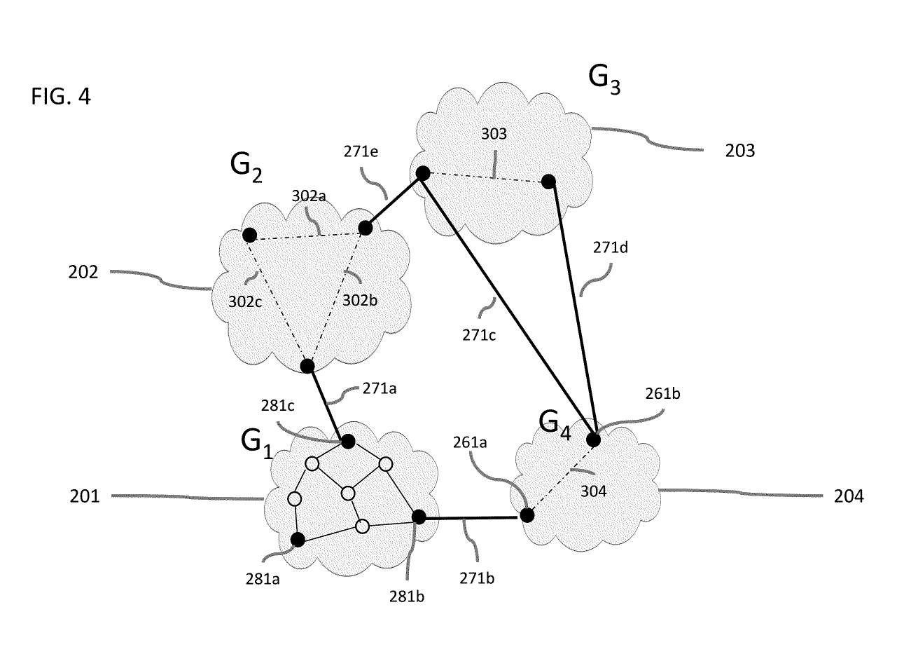

FIG. 4 illustrates an example topology corresponding to the network of FIG. 3 with four SDN domains, as seen by G1. SDN domains G2, G3 and G4 provide a summarized topology of their respective networks to G1. It has virtual links between pairs of gateway forwarders (internal to that SDN domain) and associated service-related metrics (aka feature vector), such as
1. High Bandwidth (e.g., 120 Gbps)
2. High Security (e.g., encrypted)
3. High Reliability (e.g., 99.999% reliable)
4. Non-preemptive (e.g., no traffic can bump traffic on this link)
5. Low Packet loss (<0.01%)
6. Low Packet delay and delay variation (by time of day, etc.)
7. Price schedule associated with bandwidth segments (e.g., $2/Km/hour/2 Mbps)

One or more of the above metrics can be associated with a link. While domain G4 announces a single service-enabled path, 304, between 261a and 261b, G2 announces three service-enabled paths, namely, 302a, 302b and 302c to other controllers.

In an example of G1's controller determining for a service-enabled flow path towards G3, it has the following service-enabled path options to consider:
1. Flow Path 1: G1-G2 (via 271a and 302b and 271e)-G3
2. Flow Path 2: G1-G2 (via 271a and 302c and 302a and 271e)-G3
3. Flow Path 3: G1-G4 (via 261a and 304)-G3 (via 271c)
4. Flow Path 4: G1-G4 (via 261a and 304)-G3 (via 271d)

Of course, there may be other service parameters not defined here, but the general concept is the same. Each of these flow paths has a feature vector of 7 tuples (as defined above) and a different cumulative service grade comprised of its constituent link's properties and may also have a different physical length. Once G1 makes a determination of which of these flow paths to use for the service-enabled traffic, it has to signal the controllers along the flow path. For example, if G1 selects Flow Path 4, then it has to send a so-called resource reservation message to controllers of both G4 and G3 to reserve the bandwidth during the life of the flow.

According to an aspect of this invention, each SDN controller communicates with another SDN controller (over the inter-domain control links) the following:
1. Intra-domain summarized topology update: send/update its domain's summarized topology (periodically or on a per event-basis). This topology may include the peering links attached to said domain;
2. Resource reporting: send/update feature vector associated with each link of the summarized topology (periodically or on a per event-basis. A link, for example, can be a flow path with a specific bandwidth on a set of facility. It may include the feature vector of the peering links attached to said domain;
3. Resource reservation request: request to reserve a specific link(s) and service-level(s);
4. Resource negotiation: negotiate a specific service-level of a flow with another controller;
5. Resource release notification: release a specific link reserved for a flow;
6. Control-plane topology update: send/update its inter-domain control-plane topology. This knowledge enables each SDN controller to construct the actual inter-domain control plane topology between controllers of different domains. Such an update may be required when (i) an SDN controller discovers a new SDN controller come to life; (ii) an SDN controller discovers an existing SDN controller's shut down; a new facility is added between a pair of existing SDN controllers, etc.

To summarize, according to an aspect of this invention, each SDN controller must have knowledge the following key topologies to make a determination for routing of a service-enabled flow:
1. Intra-domain actual topology: actual connectivity between forwarders (both internal and gateway) of a controller's own SDN domain, and associated service parameters. This is an actual topology, not summarized;
2. Inter-domain peering topology: actual connectivity between it's gateway forwarders and the gateway forwarders of different SDN domains, and associated service parameters;
3. Intra-domain summarized topology: an equivalent topology of each SDN domain communicated by their respective SDN controller to SDN controllers of other domains, and associated service parameters. This communication takes place on the inter-domain control links between SDN controllers. Each SDN controller periodically (or on an event-driven basis) obtains the intra-domain summarized topology from all other SDN domains' controllers as described above. Note that for each feature within the feature vector, the intra-domain summarized topology may yield a different topological layout.
4. Inter-domain control plane topology: Actual connectivity between the SDN controllers of different domains where the signaling communications take place to: (i) share summarized topology information; (ii) reserve a service-enabled flow path; (iii) negotiate service capabilities with other domains' SDN controllers; (iv) release a service-enabled flow path; (v) share inter-domain control-plane related information.

Once an SDN controller makes a determination of a flow's path across multiple domains, it must start the process of resource reservation to ensure that the determined path is available and reserved for the duration of that flow.

Resource Reservation

The most well-known protocol for resource-reservation for QoS enabled paths in the Internet is RSVP protocol. This protocol has not been widely popular in the public Internet due to scalability issues when number of routers increases along the path. However, in the context of this invention, it can be conveniently used since the number of SDN controllers along the path on the inter-domain control network is many orders smaller in number than the routers in the Internet (e.g., 8-10 SDN controllers along the path as opposed to hundreds of routers).

System Description

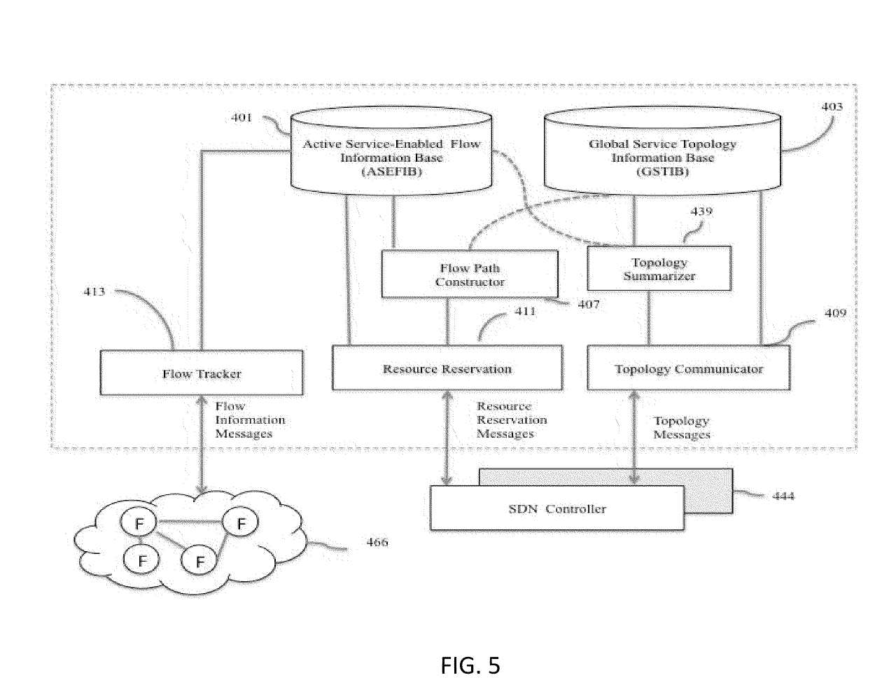

The software system of this invention is most conveniently located either within the SDN controller or as an adjunct capability attached to the SDN controller. It is comprised of several key subcomponents as illustrated in FIG. 5.

Although we have described the key functions below, there may be other auxiliary components that complement or augment these key functions that are not described here. The key subcomponents are as follows:
Global Service Topology Information Base (GSTIB)—This is a database, which contains most up to date service-enabled summarized topology information periodically collected from all other SDN controllers. This information is required to construct an inter-domain end-to-end flow path with certain service capabilities. Each database entry can be a link (virtual or real) and all associated service parameters, and possibly other relevant information (such as an aging timer). Updated virtual topology information becomes available through periodic updates or as network events occur. The database entries are updated by each SDN controller in real-time.
Active Service-Enabled Flow Information Base (ASEFIB)—This is a database of all active flows that originate, terminate and simply traverse that SDN domain. It contains associated flow-path information, service parameters, timers and other related information.
Topology Summarizer—It is essential that each controller advertised to other SDN domain controllers an accurate estimate of service parameters for virtual links between its own border gateways, since the performance of inter-domain routing will depend on these parameters. This module determines a summarized topology of the corresponding domain to share with other domains' SDN controllers. This module uses data contained in the ASEFIB and GSTIB.
Topology Communicator—This subsystem periodically communicates with other SDN controllers the summarized topology. Topology Communicator is also where the topology information from other SDN controllers is received and processed. The resultant information is sent to the database.
Resource Reservation—This is a subsystem that originates a resource reservation on a path computed by Flow Path Constructor. It generates appropriate messages to send to other SDN controllers along the computed flow path. It also receives resource reservation messages from other SDN controllers. It parses messages, and interprets and replies to such messages.
Flow Tracker—This is an application that tracks a live flow to ensure the requested service-level is delivered. It collects appropriate measurements to assess the quality of the link. It can also activate renegotiation of the path for the flow by communicating with the Resource Reservation Module.
Flow Path Constructor—This is a subsystem computes best path(s) for a service-enabled flow across multiple SDN domains using optimization algorithms of this invention. The request for a new flow path construction comes from the SDN controller when an application (such as video) starts. This application that terminates at the SDN network may make a specific request for QoS or there may be a provisioned default application type-to-QoS mapping in the Controller that triggers the process of Flow Path construction.

Each SDN domain controller has a complete control of its own intra-domain routing and cooperates with other domain controllers for inter-domain routing. For inter-domain routing, controller of the source domain: i) initially computes a number of likely paths from A (in its domain) to B (in another domain) based on its current aggregated network map (stitched from intra-domain data network and summarized topology of other domains) and associated service parameters, ii) optionally, sends messages to controllers along the likely routes to request bids (price) for the requested service parameters that vary depending on flow type: for standard flows, best effort routing is requested; for service-enabled flows, there may be different levels of service at different price ranges, iii) compares received bids and calculates the optimum virtual path fixing only the entry and exit border gateways for each domain, and notifies the controllers of each domain along the chosen path, iv) controllers of each domain along the chosen path then decide the actual physical routes to be followed in their respective domains given the entry and exit gateways. The final physical route is a concatenation of these routes.

The proposed end-to-end flow management across multiple SDN domains is the first complete architecture that enables inter-domain network information collection, route negotiation and dynamic inter-domain path allocation, while maintaining autonomy of each domain to have full control of its own domain routing.

Given the desired service level and the aggregated network model with costs and service quality variation of virtual links, the controller in the source (or destination) domain will decide for a short list of “best” inter-domain flow paths. Although there may be many ways to tackle the problem, such as using a brute-force approach to choose the best solution, it can be posed as a Constrained Least Cost (CLC) problem and algorithmically solved. The CLC problem is known to be NP-complete, so it can be solved by heuristic and approximation algorithms. A Lagrangian relaxation based aggregated cost (LARAC) algorithm can be used since it finds a good path in a short time. This problem can be easily solved over the aggregated graph (which has the full topology of the ‘self’ SDN domain, and the summarized topology of other domains). It provides a full (global) view of the simplified network with relatively small number of nodes and links. Furthermore, given the Controller of the SDN domain making the flow-path determination has a complete/full view of possible flow paths, it can apply specific constraint mask(s) (such as black listed SDN domains) to eliminate certain flow-paths before applying LARAC.

LARAC also provides a theoretical lower bound solution, which helps to evaluate quality of the result. It offers flexibility to achieve a tradeoff between optimality of the result and runtime so that it can be run in real-time. By randomly removing some links on previously calculated paths from the network, to most preferred inter-domain path candidates can be estimated.

There are two possible models for inter-controller service level negotiations. The controller of the source (or destination) domain may send messages to controllers along the path directly or may start a recursive messaging process. In recursive messaging, if controller for domain G1 wishes to send messages to controllers of domains G2, G3 and G4 for a desired route G1-G2-G3-G4, then controller G1 sends a message to only controller G2. If controller G2 cannot respond positively, then it sends a negative reply to controller G1 and no further messages are exchanged. Otherwise, controller G2 sends a request message to controller G3. The messaging process continues until a message reaches the final controller G4. If the final controller replies positively, then positive reply messages back track from G4 to G3 to G2 to G1; hence all controllers along the path have reached an agreement. The proposed recursive messaging scheme is efficient in terms of total messages exchanged between controllers to reach an SLA agreement. However, other types of messaging schemes can be implemented.

We focus on two such functionalities: end-to-end flow routing and end-to-end service provisioning. In the proposed inter-domain flow management model, each domain controller has complete control of its own intra-domain routing and cooperates with other domain controllers for inter-domain routing. For inter-domain routing, controller of the source domain: i) initially computes a number of likely paths from A (in its domain) to B (in another domain) based on its current aggregated global network map, ii) sends messages to controllers along the likely routes to request bids (price) for the requested SLA parameters that vary depending on flow type: for standard flows, best effort routing is requested; for service flows, there are levels ranging from priority queue management to virtual slice reservation, iii) compares received bids (price vs. SLA parameters), calculates the optimum virtual path fixing only the entry and exit border gateways for each domain, and notifies the controllers of each domain along the chosen path, iv) The controllers of each domain along the chosen path then decides for the actual physical routes to be followed in their respective domains given the entry and exit gateways. The final physical route is a concatenation of these routes. The proposed end-to-end flow management across multiple admin domains is the first complete architecture that enables inter-domain network information collection, route negotiation and dynamic inter-domain virtual path allocation, while maintaining autonomy of each domain to have full control of its own domain routing.

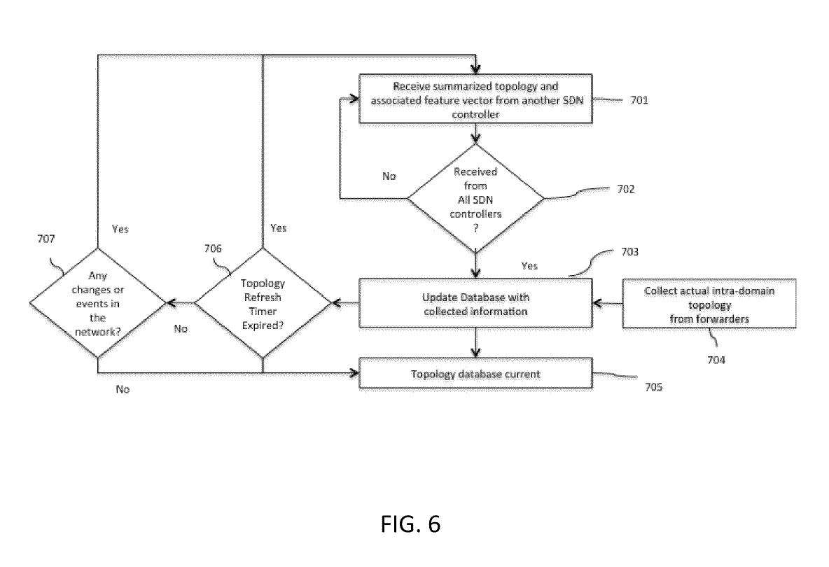

FIG. 6 illustrates an exemplifying flow chart of constructing a database of topology information collected by an SDN controller. In step 701, SDN controller receives from another SDN controller that controller's summarized network topology information and associated feature vector of each path in the topology. In step 702, it checks to determine if such information is received from all SDN controllers. If yes, in step 703 the database is updated with the received complete information as well as the most current topology information an SDN controller collects from its own network according to step 704. In step 706, the system checks to determine if it is time to refresh the topology. If so, it loops back to step 701 to collect fresh topology information. Even when the refresh timer may not have expired, there may be network events that cause outages or network performance degradation in which case the topology or associated service-levels must be updated. Step 707 checks to determine if there is an event that may drive a topology update. If so, it loops back to step 701 to collect refreshed topology information. Doing so, the topology database and features associated with flow paths are kept as current as possible.

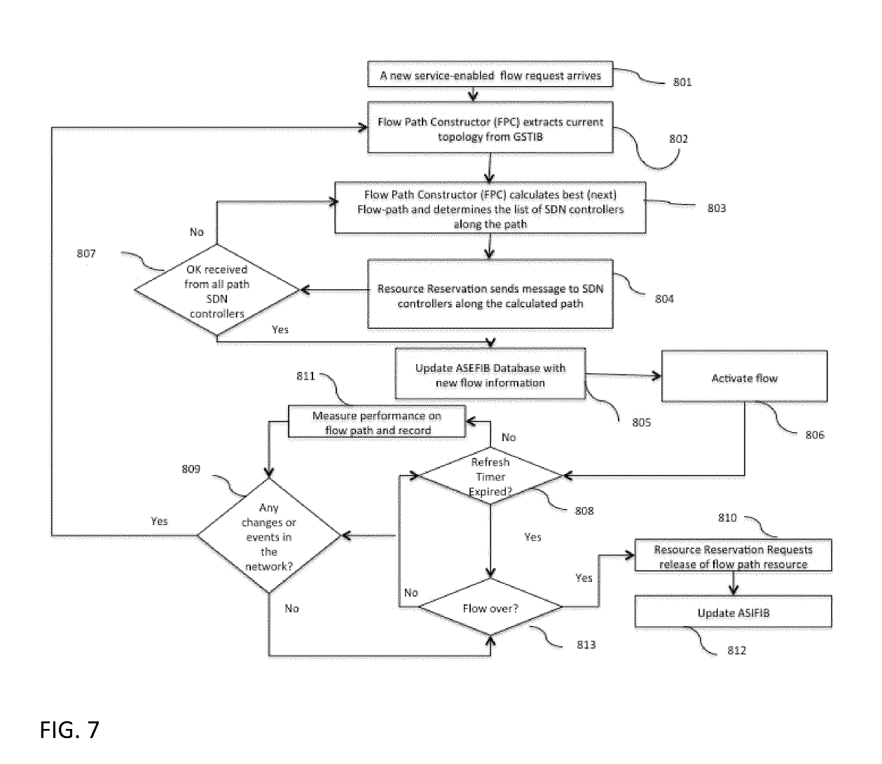

FIG. 7 illustrates an exemplifying flow-chart showing all steps of constructing a service-enabled flow path and releasing that path once the flow is over. At step 801, a request for a service-enabled flow arrives at the SDN controller. This service request may arrive through a number of ways. For example, a north-bound API of the SDN controller may be utilized to send such a request in real time. Alternatively, a web-based reservation system can be used for system administrators to enter service-enable flow requests with associated features and start-stop times on a provisioning basis. Alternatively, an application (such as video streaming) may invoke the controller for a QoS enabled flow activation. Other methods (not discussed here) may also invoke step 801. The Flow Path Constructor 407 accesses the topology database 403 in step 802, and calculates possible paths in step 803. Starting from the chosen best flow-path, the system sends resource reservation messages to SDN controllers along the path of the flow in step 804. If resource reservation does not succeed, the system loops back to the next best path in step 803 until a viable path is found, in which case Active Service Flow database (ASEFIB) 401 is updated with the new active flow information in step 805. At this stage the flow is active according to step 806. A refresh timer is simultaneously initiated to monitor the performance of the flow path. Flow Tracker 413 accesses the data network to collect performance indicators of the path in step 811. If there is a change in the network conditions causing the service-level not to be met, according to step 809, the system loops back to 802 to reconstruct the flow path. If the traffic flow is over or its timer expires according to step 813, then system sends ‘resource release message’ to other associated SDN controllers to release the path though Resource Reservation 411. Once the release is successful, it also updates ASEFIB 401 by deleting the released flow according to step 812.

The present invention also discloses a non-transitory computer-readable medium containing instructions that, when executed by a processor in a first controller in a first software defined network (SDN), cause the first controller to: store first domain topology information associated with the first SDN in a first database; transmit a first advertisement message to a second SDN controller in a second SDN domain, the first advertisement message comprising the first domain topology information associated with the first SDN, and receive a second advertisement message from a second SDN domain controller in the second SDN domain, the second advertisement message comprising second domain topology information associated with the second SDN; store the received second domain topology information associated with the second SDN in the first database, and autonomously determine an end-to-end flow path for traversal between the first and second SDN domains based on stored topology information in the first database.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

As noted above, particular embodiments of the subject matter have been described, but other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

### CONCLUSION

A system and method has been shown in the above embodiments for the effective implementation of a method and system for delivering service-enabled flow paths across multiple domains in SDN networks. While various preferred embodiments have been shown and described, it will be understood that there is no intent to limit the invention by such disclosure, but rather, it is intended to cover all modifications falling within the spirit and scope of the invention, as defined in the appended claims.

1. A software defined network (SDN) system with interdomain topology sharing comprising:
a first SDN domain comprising a first controller, a first set of forwarders, and a first storage;
a second SDN domain comprising a second controller, a second set of forwarders, and a second storage;
said first storage storing first domain topology information associated with said first SDN and second domain topology information associated with said second SDN and advertised by said second controller,
said second storage said storing second domain topology information associated with said second SDN and first domain topology information associated with said first SDN advertised by said first controller, and
wherein each of said first and second controllers autonomously determining an end-to-end flow path for traversal between said first and second SDN domains based on stored topology information.

2. The SDN system of claim 1, wherein each of said first set of forwarders and/or second set of forwarders comprise a plurality of internal forwarders and at least one gateway forwarder.

3. The SDN system of claim 1, wherein interconnectivity between said first controller and second controller in said first and second SDN domains comprises a physically separate inter-domain control plane network that is separate from a data plane associated with said first and second SDN domains.

4. The SDN system of claim 1, wherein interconnectivity between said first controller and second controller in said first and second SDN domains comprises an inter-domain control plane network that shares the data plane associated with said first and second SDN domains.

5. The SDN system of claim 1, wherein said first storage and second storage comprises a first and second database.

6. The SDN system of claim 1, wherein said end-to-end flow path that is autonomously determined by each of said first and second controllers is determined at least in part based on a pre-determined algorithm.

7. The SDN system of claim 6, wherein said algorithm is any of, or a combination of, the following: brute-force algorithm, heuristic algorithm, approximation algorithm, and Lagrangian relaxation based aggregated cost (LARAC) algorithm.

8. The SDN system of claim 1, wherein said end-to-end flow path that is autonomously determined by each of said first and second controllers is determined at least in part based on a pre-determined service level that has to be satisfied.

9. A method as implemented in a first controller in a first software defined network (SDN) comprising:
storing first domain topology information associated with said first SDN in a first database;
transmitting on said inter-domain control network a first advertisement message to a second SDN controller in a second SDN domain, said first advertisement message comprising said first domain topology information associated with said first SDN, and receiving on said inter-domain control network a second advertisement message from a second SDN domain controller in said second SDN domain, said second advertisement message comprising second domain topology information associated with said second SDN;
storing said received second domain topology information associated with said second SDN in said first database, and
wherein said first controller autonomously determining an end-to-end flow path for traversal between said first and second SDN domains based on stored topology information in said first database.

10. The method of claim 9, wherein said end-to-end flow path that is autonomously determined by said first controller is determined at least in part based on a pre-determined algorithm.

11. The method of claim 9, wherein said algorithm is any of, or a combination of, the following: brute-force algorithm, heuristic algorithm, approximation algorithm, and Lagrangian relaxation based aggregated cost (LARAC) algorithm.

12. The method of claim 9, wherein said end-to-end flow path that is autonomously determined by said first controller is determined at least in part based on a pre-determined service level that has to be satisfied.

13. A first software defined network (SDN) controller that is part of a first SDN domain and operable on an Internet protocol (IP) based network system comprising:
(a) a service topology information base sub-system storing data of available active service enabled paths and associated service metrics between end points in said first SDN domain and a second SDN domain constructed based on service topology information gathered by said first SDN controller and service topology messages advertised by a second SDN controller associated with said second SDN domain;
(b) a flow path constructor sub-system determining an end-to-end flow path between said end points based on both multiple service path topology alternatives stored in said service topology information base sub-system and a pre-determined algorithm; and
(c) a resource reservation sub-system communicating with said second controller in said second SDN domain to negotiate and reserve said end-to-end flow path before the flow becomes active, to renegotiate flow path when the service requirements are no longer met, and to release said flow path after it is no longer needed.

14. The first SDN controller of claim 13, wherein said algorithm is any of, or a combination of, the following: brute-force algorithm, heuristic algorithm, approximation algorithm, and Lagrangian relaxation based aggregated cost (LARAC) algorithm.

15. The first SDN controller of claim 13, wherein said first SDN controller further comprises a flow tracker sub-system to monitor and track said end-to-end flow path once activated.

16. The first SDN controller of claim 13, wherein said first SDN controller further comprises a topology summarizer sub-system to determine a summarized service-enabled topology/graph of said first SDN domain to be communicated to said second controller in said second SDN domain.

17. The first SDN controller of claim 13, wherein said first SDN controller further comprises a topology communicator sub-system to advertise summarized service-enabled topology/graph of said first SDN domain to said second controller in said second SDN domain.

18. A non-transitory computer-readable medium containing instructions that, when executed by a processor in a first controller in a first software defined network (SDN), cause said first controller to:
store first domain topology information associated with said first SDN in a first database;
transmit a first advertisement message to a second SDN controller in a second SDN domain, said first advertisement message comprising said first domain topology information associated with said first SDN, and receive a second advertisement message from a second SDN domain controller in said second SDN domain, said second advertisement message comprising second domain topology information associated with said second SDN;
store said received second domain topology information associated with said second SDN in said first database, and
autonomously determine an end-to-end flow path for traversal between said first and second SDN domains based on stored topology information in said first database.

19. The non-transitory computer-readable medium of claim 18, wherein said end-to-end flow path that is autonomously determined by said first controller is determined at least in part based on a pre-determined algorithm.

20. The non-transitory computer-readable medium of claim 18, wherein said algorithm is any of, or a combination of, the following: brute-force algorithm, heuristic algorithm, approximation algorithm, and Lagrangian relaxation based aggregated cost (LARAC) algorithm.

21. The non-transitory computer-readable medium of claim 18, wherein said end-to-end flow path that is autonomously determined by said first controller is determined at least in part based on a pre-determined service level that has to be satisfied.
